(19) United States
(12) Patent Application Publication
(10) Pub. No.: US 2022/0413518 A1
(43) Pub. Date: Dec. 29, 2022

(54) MOVABLE OBJECT, INFORMATION PROCESSING METHOD, PROGRAM, AND INFORMATION PROCESSING SYSTEM

(71) Applicant: SONY GROUP CORPORATION, Tokyo (JP)

(72) Inventor: SHUN LEE, TOKYO (JP)

(21) Appl. No.: 17/769,840

(22) PCT Filed: Oct. 12, 2020
(86) PCT No.: PCT/JP2020/038505

§ 371 Date: Apr. 18, 2022

(30) Foreign Application Priority Data
Oct. 24, 2019 (JP) 2019-193263

(51) Int. Cl. G05D 1/10; B64C 39/02

(52) U.S. Cl. CPC G05D 1/106; B64C 39/024; B64C 2201/127

(57) ABSTRACT

Proposed is a technology capable of performing an action for examining a object difficult to be recognized, to thereby avoid the collision between the obstacle and the movable object. A movable object of the present technology includes a control unit. The control unit controls an action of a movable object on the basis of an estimation result of estimating whether or not an obstacle that prevents movement of the movable object exists on the basis of an image captured by an imaging unit.

### TECHNICAL FIELD

The present technology relates to a movable object, an information processing method, a program, and an information processing system.

### BACKGROUND ART

In recent years, there has been proposed utilizing a movable object such as a drone for aerial photography of a scene, for example. In such a movable object, a technology of stably avoiding obstacles is employed (e.g., Patent Literature 1).

### CITATION LIST

### Patent Literature

Patent Literature 1: Japanese Patent Application Laid-open No. 2005-316759

### DISCLOSURE OF INVENTION

### Technical Problem

In general, drones need to detect obstacles for preventing their damage. However, in a case where the obstacles are transparent objects such as window glasses and mirrors or fine objects difficult to be recognized, it is difficult for drones to detect such obstacles by normal obstacle detection utilizing ToF and stereo cameras, and the drones may collide with the obstacles during the flight.

In view of this, the present disclosure proposes a technology capable of avoiding the collision between an obstacle and a movable object.

### Solution to Problem

In order to solve the above-mentioned problem, a movable object according to an embodiment of the present technology includes a control unit.

The control unit controls an action of a movable object on the basis of an estimation result of estimating whether or not an obstacle that prevents movement of the movable object exists on the basis of an image captured by an imaging unit.

The control unit may cause the movable object to decelerate or hover in a case where it is estimated that the obstacle exists.

The control unit may perform processing of examining whether or not the obstacle really exists in a case where it is estimated that the obstacle exists.

The movable object may further include

a detection unit that detects a distance between the obstacle and the movable object, in which

the control unit may move the movable object to a position where the detection unit is capable of detecting the distance.

The movable object may further include

a detection unit that detects a distance between the obstacle and the movable object, in which

the control unit may cause the detection unit to measure the distance multiple times while moving the movable object.

The control unit may cause the movable object to land or hover or may generate a movement path of the movable object to avoid the obstacle in a case where the control unit determines that the obstacle really exists.

The control unit may control the action of the movable object on the basis of an estimation result of estimating whether or not the obstacle exists by applying the image to a learner generated by applying learning data to a machine learning algorithm.

The movable object may be an aircraft.

The obstacle may be an object having transparency or translucency.

In order to solve the above-mentioned problem, an information processing system according to an embodiment of the present technology includes an information processing apparatus and a movable object.

The information processing apparatus estimates whether or not an obstacle that prevents movement of the movable object exists on the basis of an image captured by an imaging unit.

The movable object controls the action of the movable object on the basis of an estimation result.

The information processing apparatus may estimate whether or not the obstacle exists by applying the image to a learner generated by applying learning data to a machine learning algorithm.

The information processing apparatus may be a server.

In order to solve the above-mentioned problem, an information processing method according to an embodiment of the present technology includes controlling an action of a movable object on the basis of an estimation result of estimating whether or not an obstacle that prevents movement of the movable object exists on the basis of an image captured by an imaging unit.

In order to solve the above-mentioned problem, a program according to an embodiment of the present technology causes a movable object to execute the following step.

A step of controlling an action of the movable object on the basis of an estimation result of estimating whether or not an obstacle that prevents movement of the movable object exists on the basis of an image captured by an imaging unit.

### BRIEF DESCRIPTION OF DRAWINGS

FIG. 1 A schematic diagram showing a configuration example of an information processing system according of the present technology.

FIG. 2 A block diagram showing a configuration example of the information processing system.

FIG. 3 A block diagram showing a hardware configuration example of a drone and an information processing apparatus.

FIG. 4 A flowchart showing a flow of a typical operation of the information processing system.

FIG. 5 A flowchart showing one process of the operation in detail.

FIG. 6 A diagram schematically showing a processing procedure of a typical specialized AI.

FIG. 7 A flowchart showing one process of the operation in detail.

FIG. 8 A conceptual diagram showing the drone and the obstacle together.

FIG. 9 A graph plotting the existence probability of the obstacle in a manner that depends on a distance between the drone and the obstacle.

FIG. 10 A conceptual diagram showing the drone and the obstacle together.

FIG. 11 A graph plotting the existence probability of the obstacle in a manner that depends on a movement distance of the drone.

### MODE(S) FOR CARRYING OUT THE INVENTION

Hereinafter, an embodiment of the present technology will be described with reference to the drawings.

<Configuration of Information Processing System>

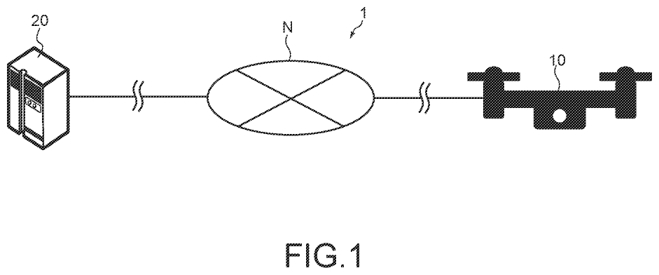

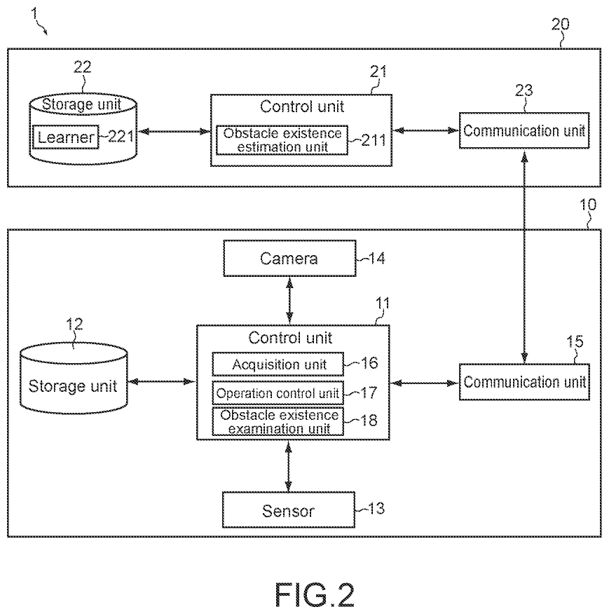

FIG. 1 is a diagram showing a configuration example of an information processing system 1 according to this embodiment. FIG. 2 is a block diagram showing a configuration example of the information processing system 1. The information processing system 1 includes, as shown in FIG. 1, a drone 10 and an information processing apparatus 20.

The drone 10 and the information processing apparatus 20 are connected to be capable of communicating with each other via a network N. The network N may be the Internet, a mobile communication network, a local area network, or the like or may be a network combining a plurality of types of networks of them.

[Drone]

As shown in FIG. 2, the drone 10 includes a control unit 11, a storage unit 12, a sensor 13, a camera 14, and a communication unit 15. The drone 10 is an example of a “movable object” in the scope of claims.

The control unit 11 controls general operations of the drone 10 or some of them in accordance with programs stored in the storage unit 12. The storage unit 12 stores sensor data output from the sensor 13, image data acquired from the camera 14, and the like.

The control unit 11 functionally has an acquisition unit 16, an operation control unit 17, and an obstacle existence examination unit 18.

The acquisition unit 16 acquires sensor data detected by the sensor 13 and image data acquired by the camera 14. The operation control unit 17 controls the speed and the sensor 13 of the drone 10 on the basis of determinations of the obstacle existence estimation unit 211 or the obstacle existence examination unit 18.

After the drone 10 is controlled by the operation control unit 214, the obstacle existence examination unit 18 determines whether or not an obstacle really exists. The obstacle in this embodiment is, for example, a transparent object having transparency or translucency such as a window glass, or an object difficult to be recognized such as a fine mesh and an electric wire, and the same applies to the following description.

The sensor 13 includes a ranging sensor such as a sonar, radar, and lidar, a GPS sensor that measures positional information of the drone 10, and the like. The sensor 13 is an example of a “detection unit” in the scope of claims.

The communication unit 15 communicates with an information processing apparatus 20 through a network N. The communication unit 15 functions as a communication interface of the drone 10.

The camera 14 is an apparatus that generates a captured image by capturing a real space through, for example, an imaging device such as a complementary metal oxide semiconductor (CMOS) and a charge coupled device (CCD), and various members such as a lens for controlling imaging of a subject image to the imaging device.

The camera 14 may capture a still image or may capture a moving image. The camera 14 is connected to the main body of the drone 10 via a drive mechanism (not shown) such as a three-axis gimbal, for example.

[Information Processing Apparatus]

As shown in FIG. 2, the information processing apparatus 20 includes a communication unit 23, a control unit 21, and a storage unit 22. The information processing apparatus 20 is typically a server apparatus, though not limited thereto. The information processing apparatus 20 may be any other computer such as a PC.

Alternatively, the information processing apparatus 20 may be an air-traffic control apparatus that performs flight control of giving directions to the drone 10 to guide it.

The communication unit 23 communicates with the drone 10 via the network N. The communication unit 23 functions as a communication interface of the information processing apparatus 20.

The control unit 21 controls general operations of the information processing apparatus 20 or some of them in accordance with programs stored in the storage unit 22. The control unit 21 corresponds to a “control unit” in the scope of claims.

The control unit 21 functionally has the obstacle existence estimation unit 211. The obstacle existence estimation unit 211 determines whether or not there is an obstacle that prevents the flight of the drone 10 in the real space in which the drone 10 exists.

[Hardware Configuration]

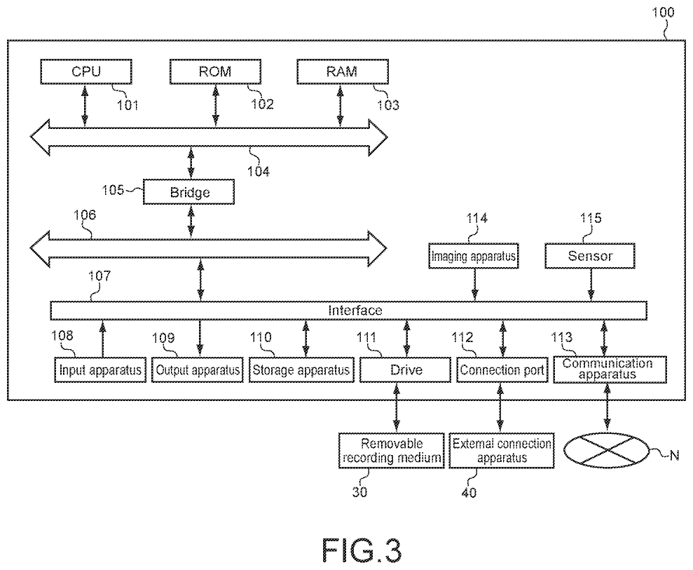

FIG. 3 is a block diagram showing a hardware configuration example of the drone 10 and the information processing apparatus 20. The drone 10 and the information processing apparatus 20 may be realized by an information processing apparatus 100 shown in FIG. 3.

The information processing apparatus 100 has a central processing unit (CPU) 101, a read only memory (ROM) 102, and a random access memory (RAM) 103. The control units 11 and 21 may be the CPU 101.

The information processing apparatus 100 may be configured to have a host bus 104, a bridge 105, an external bus 106, an interface 107, an input apparatus 108, an output apparatus 109, a storage apparatus 110, a drive 111, a connection port 113, and a communication apparatus 113.

Moreover, the information processing apparatus 100 may be configured to have an imaging apparatus 114 and a sensor 115. In addition, the information processing apparatus 100 may include, instead of or in addition to the CPU 101, a processing circuit such as a digital signal processor (DSP), an application specific integrated circuit (ASIC), and a graphics processing unit (GPU).

The CPU 101 functions as an arithmetic processing apparatus and a control apparatus, and controls general operations in the information processing apparatus 100 or some of the general operations in accordance with various programs recorded in the ROM 102, the RAM 103, the storage apparatus 110, or a removable recording medium 30. The storage units 12 and 22 may be the ROM 102, the RAM 103, the storage apparatus 110, or the removable recording medium 30.

The ROM 102 stores programs, operation parameters, and the like to be used by the CPU 101. The RAM 103 temporarily stores programs to be used in execution of the CPU 101, parameters to be changed as appropriate in the execution, and the like.

The CPU 101, the ROM 102, and the RAM 103 are connected to one another via the host bus 104 constituted by an internal bus such as a CPU bus. In addition, the host bus 104 is connected to the external bus 106 such as a peripheral component interconnect/interface (PCI) bus via the bridge 105.

The input apparatus 108 includes, for example, an apparatus that the user operates, such as a mouse, a keyboard, a touch panel, a button, a switch, a lever, and the like. The input apparatus 108 may be, for example, a remote control apparatus utilizing infrared rays or other radio waves, or may be an external connection apparatus 40 compatible with operations of the information processing apparatus 100, such as a portable phone.

The input apparatus 108 includes an input control circuit that generates an input signal on the basis of information input by the user and outputs the input signal to the CPU 101. The user operates this input apparatus 108 to thereby input various types of data into the information processing apparatus 100 or instruct the information processing apparatus 100 to perform a processing operation.

The output apparatus 109 is constituted by an apparatus capable of notifying the user of acquired information by the use of a sense such as a sense of sight, a sense of hearing, and a sense of touch. The output apparatus 109 can be, for example, a display apparatus such as a liquid crystal display (LCD) and an organic electro-luminescence (EL) display, an audio output apparatus such as a speaker and headphones, a vibrator, or the like.

The output apparatus 109 outputs results obtained by the processing of the information processing apparatus 100, as pictures such as texts and images, sounds such as speech and acoustic sounds, vibrations, or the like.

The storage apparatus 110 is an apparatus for storing data, which is configured as an example of the storage unit of the information processing apparatus 100. The storage apparatus 110 is constituted by, for example, a magnetic storage device such as a hard disk drive (HDD), a semiconductor storage device, an optical storage device, a magneto-optical storage device, and the like. The storage apparatus 110 stores, for example, programs and various types of data to be executed by the CPU 101, various types of data externally acquired, and the like.

The drive 111 is a reader/writer for the removable recording medium 30 such as a magnetic disk, an optical disc, a magneto-optical disk, and a semiconductor memory. The drive 111 is built in the information processing apparatus 100 or externally connected to the information processing apparatus 100. The drive 111 reads information recorded on the mounted removable recording medium 30 and outputs the information to the RAM 103. Moreover, the drive 111 writes records on the mounted removable recording medium 30.

A connection port 112 is a port for connecting an apparatus to the information processing apparatus 100. The connection port 112 can be, for example, a universal serial bus (USB) port, an IEEE1394 port, a small computer system interface (SCSI) port, or the like.

Moreover, the connection port 112 may be an RS-232C port, an optical audio terminal, a high-definition multimedia interface (HDMI) (registered trademark) port, or the like. By connecting the external connection apparatus 40 to the connection port 112, various types of data are exchanged between the information processing apparatus 100 and the external connection apparatus 40.

The communication apparatus 113 is, for example, a communication interface constituted by a communication device for connecting to the network N and the like. The communication apparatus 113 can be, for example, a local area network (LAN), Bluetooth (registered trademark), Wi-Fi, a communication card for a wireless USB (WUSB) or long term evolution (LTE), or the like. Alternatively, the communication apparatus 113 may be a router for optical communication, a router for an asymmetric digital subscriber line (ADSL), various modems for communication, or the like.

The communication apparatus 113 sends and receives, for example, signals and the like by using a predetermined protocol such as TCP/IP to/from the Internet or another communication apparatus. Moreover, the network N connected to the communication apparatus 113 is a network connected with a wire or wirelessly, and can include, for example, the Internet, a household LAN, infrared communication, radio communication, near-field communication, satellite communication, and the like. The communication units 15 and 23 may be the communication apparatus 113.

The imaging apparatus 114 is an apparatus that captures an image of a real space and generates the captured image. The camera 14 corresponds to the imaging apparatus 114.

The sensor 115 includes, for example, various sensors such as an acceleration sensor, an angular velocity sensor, a geomagnetic sensor, an illuminance sensor, a temperature sensor, an atmospheric pressure sensor, and a sound sensor (microphone).

The sensor 115 acquires, for example, information about states of the information processing apparatus 100 itself, such as an attitude of a casing of the information processing apparatus 100 and information about the surrounding environment of the information processing apparatus 100, such as brightness and noise in the periphery of the information processing apparatus 100. Moreover, the sensor 115 may include a GPS receiver that receives global positioning system (GPS) signals and measures latitude, longitude, and altitude of the apparatus. The sensor 13 corresponds to the sensor 115.

Hereinabove, the configuration example of the information processing system 1 has been shown. Each of the above-mentioned components may be configured by using a general-purpose members or may be configured by using a member specialized for the function of each component. Such a configuration can be changed as appropriate in accordance with the state-of-the-art at each time when the configuration is carried out.

<Operation of Information Processing System>

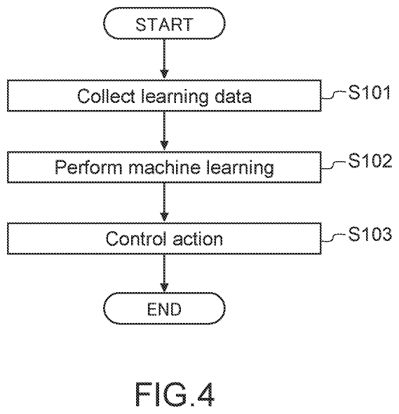

FIG. 4 is a flowchart showing a flow of a typical operation of the information processing system 1. Hereinafter, the operation of the information processing system 1 will be described referring to FIG. 4 as appropriate.

[Step S101: Learning Data Collection]

First of all, the obstacle existence estimation unit 211 acquires data (hereinafter, learning data) in which image data captured by the camera 14 at a predetermined frame rate (e.g., several tens of fps) is associated with action results of the drone 10 in a case where the image data is captured. At this time, the user transmits the learning data as an error report to the information processing apparatus 20 via an arbitrary device (not shown), for example, and the learning data is stored in the storage unit 22.

Here, the above-mentioned action results refer to, for example, an action in which the drone 10 collides with an obstacle existing in the real space and crashes and an action in which the drone 10 suddenly stops in front of an obstacle, and the same applies to the following description.

[Step S102: Machine Learning]

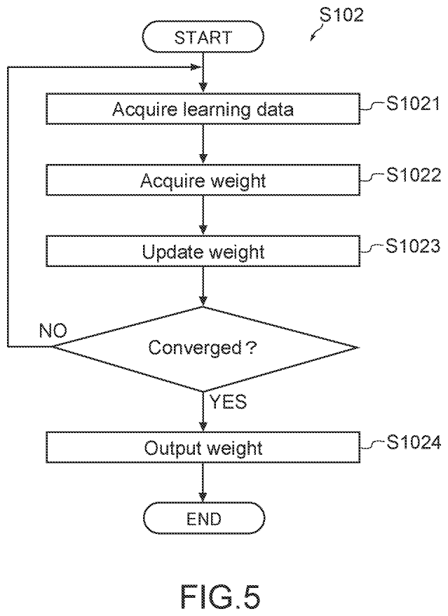

FIG. 5 is a flowchart showing the details of Step S102. Hereinafter, Step S102 will be described referring to FIG. 5 as appropriate.

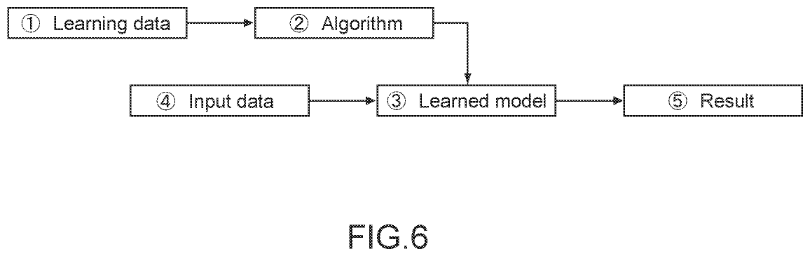

The information processing apparatus 20 of this embodiment is an information processing apparatus using a so-called specialized artificial intelligence (AI) that replaces the user's intelligent tasks. FIG. 6 is a diagram schematically showing a processing procedure of a typical specialized AI.

The specialized AI is, as a large framework, a mechanism in which results can be obtained by applying any input data to a learned model built by incorporating learning data into an algorithm that functions as a learning program.

The obstacle existence estimation unit 211 reads the learning data stored in the storage unit 22 (S1021). This learning data corresponds to “learning data” in FIG. 6.

Next, the obstacle existence estimation unit 211 generates a learner by applying the learning data, which has been read from the storage unit 22, to a preset algorithm. It should be noted that the algorithm described above corresponds to an “algorithm” in FIG. 6, and is, for example, a machine learning algorithm.

The types of machine learning algorithm are not particularly limited, and the machine learning algorithm may be an algorithm using a neural network such as a recurrent neural network (RNN), a convolutional neural network (CNN), a generative adversarial network (GAN), and a multilayer perceptron (MLP). Alternatively, the machine learning algorithm may be any algorithm for performing a supervised learning method (boosting method, a support vector machine (SVM) method, a support vector regression method (SVR) method, etc.), an unsupervised learning method, a semi-supervised learning method, an enhanced learning method, or the like.

In this embodiment, the MLP and its extension, the CNN, are typically employed as algorithms used for building the learner.

The MLP is a type of neural network. It is known that any nonlinear function can be approximated by a three-layer neural network if there are an infinite number of neurons in a hidden layer H. The MLP has conventionally been a three-layer neural network in many cases. Therefore, in this embodiment, a case where the MLP is a three-layer neural network will be described as an example.

The obstacle existence estimation unit 211 acquires (Step S1022) connection weights of the three-layer neural network, which have been stored in the storage unit 22, and applies the connection weights to a sigmoid function to thereby generate a learner. Specifically, assuming that an input stimulus to the i-th neuron Ii in an input layer I is denoted by xi and a connection weight of Ii and the j-th neuron in the hidden layer H is denoted by θIji, an output zj of the hidden layer H is expressed by Equation (1) below, for example.

$$\begin{matrix}[ Formula 1 ] & \\ {z}_{j} = sigmoid ( {\sum }_{i} {θ}_{lji} {x}_{i} ) & ( 1 )\end{matrix}$$

The “sigmoid” denotes the sigmoid function and is expressed by Equation (2) below. In a case where a=1, it is a standard sigmoid function.

$$\begin{matrix}[ Formula 2 ] & \\ sigmoid ( x ) = \frac{1}{1 + exp ( - a x )} & ( 2 )\end{matrix}$$

Similarly, an output signal yk of the k-th neuron in an output layer O is expressed by Equation (3) below, for example. It should be noted that in a case where the output space of the output layer O is taken for all real values, the sigmoid function of the output layer O is omitted.

$$\begin{matrix}[ Formula 3 ] & \\ {y}_{k} = sigmoid ( {\sum }_{j} {θ}_{Hkj} {z}_{j} ) & ( 3 )\end{matrix}$$

Here, the notation for each element using in Equations (1) and (3) is expressed more simply by applying the sigmoid function for each dimension. Specifically, assuming that an input signal, a hidden layer signal, and an output signal are represented by vectors, respectively, as x, y, z, and a connection weight relating to the input signal and a connection weight relating to the hidden layer output are respectively represented by W_{I}=[θ_{Iji}], W_{H}=[θ_{Hkj}], the output signal y, that is, the learner is represented by Equation (4) below. W_{I} and W_{H} are internal parameters (weights) of the three-layer neural network.

[Formula 4]

Y=f(x;W_{I},W_{H})=W_{H}sigmoid(W_{I}x) (4)

In Step S102 of this embodiment, since the supervised learning is typically employed, the obstacle existence estimation unit 211 performs processing of updating the learner until the output error is minimized (Step S1023). Specifically, the obstacle existence estimation unit 211 sets the image data and the action result for building the learning data as an input signal and a supervisor signal (supervisor data), respectively, and updates the internal parameters W_{I} and W_{H} until the error between the output signal obtained by applying the input signal to Equation (4) and the supervisor signal converges. The obstacle existence estimation unit 211 outputs to the storage unit 22 the internal parameters W_{I(min)} and W_{H(min)} in which the error is minimized (Step S1024).

The obstacle existence estimation unit 211 reads the internal parameters W_{I(min)} and W_{H(min)} stored in the storage unit 22 and builds a learner 221 in the storage unit 22 by applying them to Equation (4). The learner 221 corresponds to a “learned model” in FIG. 6.

[Step S103: Action Control]

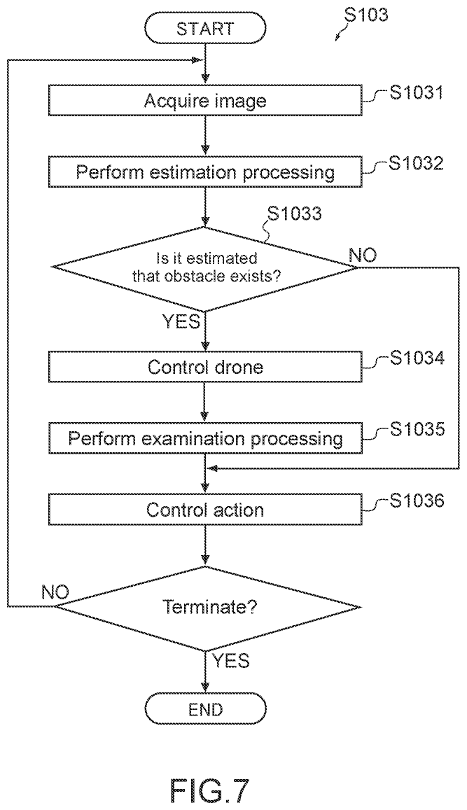

FIG. 7 is a flowchart showing the details of Step S103. Hereinafter, Step S103 will be described referring to FIG. 7 as appropriate.

The obstacle existence estimation unit 211 acquires an image captured at a predetermined frame rate (e.g., several tens of fps) from the camera 14 (Step S1031). This image corresponds to “input data” in FIG. 6.

Next, the obstacle existence estimation unit 211 estimates whether or not an obstacle exists in the image by applying the learner 221 to the image acquired in the previous step S1031 (Step S1032), and outputs the estimation result to the operation control unit 17. The estimation result corresponds to a “result” in FIG. 6.

Here, in a case where the obstacle existence estimation unit 211 estimates that an obstacle exists in the image captured in the previous step S1031 (YES in Step S1033), the obstacle existence estimation unit 211 outputs an instruction to cause the drone 10 in flight to decelerate or hover to the operation control unit 17, and the operation control unit 17 performs this instruction (Step S1034). Accordingly, the drone 10 hovers or decelerates regardless of whether an obstacle really exists, and therefore collision between the obstacle and the drone 10 is avoided.

Next, in Step S1035, the obstacle existence examination unit 18 examines whether or not the obstacle estimated to exist in the previous step S1032 really exists. Hereinafter, some application examples of Step S1035 will be described.

### Application Example 1

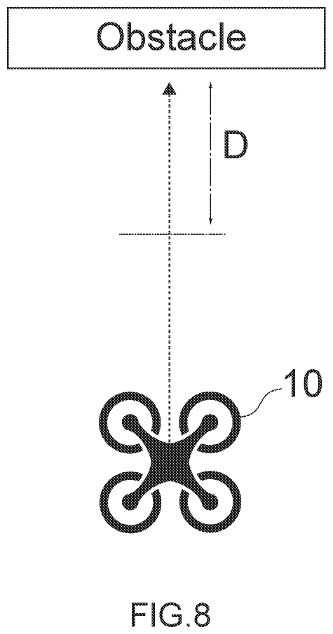

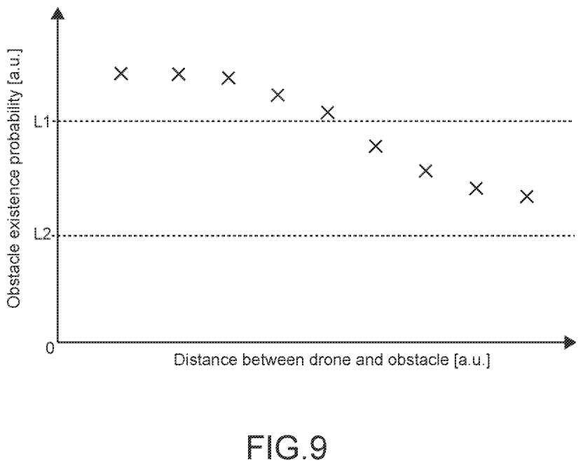

FIG. 8 is a conceptual diagram showing the drone 10 and the obstacle together and FIG. 9 is a graph plotting the existence probability of the obstacle that depends on a distance between the drone 10 and the obstacle. In a case where it is estimated that an obstacle exists in the previous step S1032, the obstacle existence examination unit 18 outputs an instruction to move the drone 10 to a position away from the obstacle by a predetermined distance D to the operation control unit 17, and the operation control unit 17 performs this instruction. The predetermined distance D is a distance at which the sensor 13 is capable of measuring the distance between the drone 10 and the obstacle.

At this time, the obstacle existence examination unit 18 outputs to the sensor 13 an instruction to measure the distance between the drone 10 and the obstacle multiple times while making the drone 10 approach the obstacle, and the sensor 13 performs this instruction. It should be noted that as it can be seen from FIG. 9, as the distance between the drone 10 and the obstacle becomes shorter, the existence probability of the obstacle becomes higher.

### Application Example 2

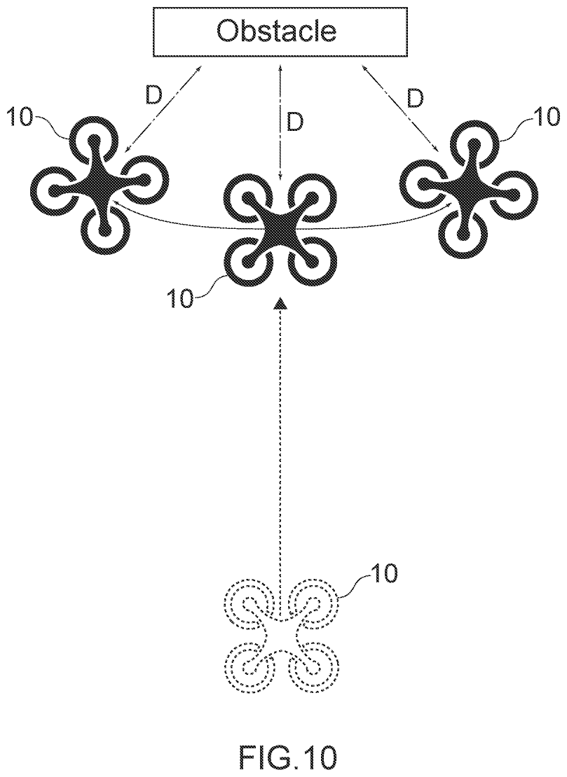

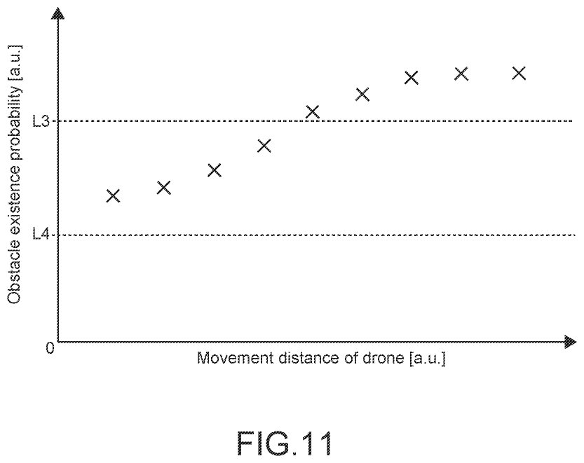

FIG. 10 is a conceptual diagram showing the drone 10 and the obstacle together and FIG. 11 is a graph plotting the existence probability of the obstacle that depends on a movement distance of the drone 10. In a case where it is estimated that an obstacle exists in the previous step S1032, the obstacle existence examination unit 18 outputs an instruction to move the drone 10 to a position away from the obstacle by a predetermined distance D to the operation control unit 17, and the operation control unit 17 performs this instruction.

Next, the obstacle existence examination unit 18 outputs to the operation control unit 17 an instruction to move the drone 10 while maintaining the predetermined distance D after moving the drone 10 to the predetermined distance D, and the operation control unit 17 performs this instruction.

At this time, the obstacle existence examination unit 18 outputs to the sensor 13 an instruction to measure the distance between the drone 10 and the obstacle multiple times, and the sensor 13 performs this instruction. It should be noted that as it can be seen from FIG. 11, the movement distance of the drone 10 becomes longer, the existence probability of the obstacle becomes higher.

On the other hand, in a case where the obstacle existence estimation unit 211 estimates that no obstacle exists in the image captured in the previous step S1031 (NO of Step S1033), the obstacle existence estimation unit 211 outputs an instruction to continue the flight to the operation control unit 17, and the operation control unit 17 performs this instruction.

Subsequently, in a case where it is determined that the obstacle really exists in the previous step S1035, specifically, in a case where the existence probability of the obstacle exceeds a predetermined threshold L1, L3 when the distance between the drone 10 and the obstacle is measured multiple times, the operation control unit 17 causes the drone 10 to land or hover. Alternatively, the operation control unit 17 generates a movement path to avoid the obstacle and performs flight control according to this movement path (Step S1036). Accordingly, collision between the drone 10 and the obstacle is reliably avoided.

On the other hand, in a case where it is determined that the obstacle does not really exist in the previous step S1035, specifically, in a case where the existence probability of the obstacle falls below a predetermined threshold L2, L4 when the distance between the drone 10 and the obstacle is measured multiple times, the operation control unit 17 cancels the control imposed on the drone 10 in the previous step S1034.

### Modified Examples

Hereinabove, the embodiment of the present technology has been described, though the present technology is not limited to the above-mentioned embodiment. Various modifications can be made as a matter of course.

For example, in the above-mentioned embodiment, the drone 10 is caused to decelerate or hover in a case where it is estimated that an obstacle exists by applying an image captured by the camera 14 to the learner 221, though not limited thereto. The drone 10 may be caused to decelerate or hover by recognizing an obstacle in the image in accordance with a predetermined algorithm that recognizes a specific object.

Moreover, in the above-mentioned embodiment, in a case where the presence or absence of an obstacle is examined in the previous step S1035, the drone 10 is caused to approach the obstacle and the distance between the drone 10 and the obstacle is detected multiple times, though not limited thereto. The drone 10 may be rotated so that the sensor 13 or the camera 14 faces the obstacle in addition to or instead of such an operation.

<Supplements>

The present technology may be applied to movable objects (e.g., robots) other than the flying objects and the applications are not particularly limited. It should be noted that the flying objects include aircraft, unmanned aircraft, unmanned helicopters, and the like other than the drone. In addition, in the above-mentioned embodiment, the descriptions have been given on the premise that the drone 10 flies outside, though the present technology may be applied to, for example, a movable object that moves inside.

In addition, the effects described in this specification are merely illustrative or exemplary and not limitative. That is, in addition to or instead of the above-mentioned effects, the present technology can provide other effects obvious to a person skilled in the art in light of the descriptions in this specification.

Although the favorable embodiment of the present technology has been described above in detail with reference to the accompanying drawings, the present technology is not limited to such examples. It is obvious that a person having an ordinary skill in the art of the present technology can conceive various variants or modifications within the scope of the technical ideas described in the scope of claims, and it should be understood that these variants or modifications also fall within the technical scope of the present technology as a matter of course.

It should be noted that the present technology may also take the following configurations.

(1)

A movable object, including

a control unit that controls an action of a movable object on the basis of an estimation result of estimating whether or not an obstacle that prevents movement of the movable object exists on the basis of an image captured by an imaging unit.

(2)

The movable object according to (1), in which

the control unit causes the movable object to decelerate or hover in a case where it is estimated that the obstacle exists.

(3)

The movable object according to (1) or (2), in which

the control unit performs processing of examining whether or not the obstacle really exists in a case where it is estimated that the obstacle exists.

(4)

The movable object according to (3), further including

a detection unit that detects a distance between the obstacle and the movable object, in which

the control unit moves the movable object to a position where the detection unit is capable of detecting the distance.

(5)

The movable object according to (3) or (4), further including

a detection unit that detects a distance between the obstacle and the movable object, in which

the control unit causes the detection unit to measure the distance multiple times while moving the movable object.

(6)

The movable object according to any one of (3) to (5), in which

the control unit causes the movable object to land or hover or generates a movement path of the movable object to avoid the obstacle in a case where the control unit determines that the obstacle really exists.

(7)

The movable object according to any one of (1) to (6), in which the control unit controls the action of the movable object on the basis of an estimation result of estimating whether or not the obstacle exists by applying the image to a learner generated by applying learning data to a machine learning algorithm.

(8)

The movable object according to any one of (1) to (7), in which

the movable object is an aircraft.

(9)

The movable object according to any one of (1) to (8), in which

the obstacle is an object having transparency or translucency.

(10)

An information processing system, including:

an information processing apparatus that estimates whether or not an obstacle that prevents movement of the movable object exists on the basis of an image captured by an imaging unit; and

the movable object that controls the action of the movable object on the basis of an estimation result.

(11)

The information processing system according to (10), in which

the information processing apparatus estimates whether or not the obstacle exists by applying the image to a learner generated by applying learning data to a machine learning algorithm.

(12)

The information processing system according to (10) or (11), in which

the information processing apparatus is a server.

(13)

An information processing method, including

controlling an action of a movable object on the basis of an estimation result of estimating whether or not an obstacle that prevents movement of the movable object exists on the basis of an image captured by an imaging unit.

(14)

A program that causes a movable object to execute

a step of controlling an action of the movable object on the basis of an estimation result of estimating whether or not an obstacle that prevents movement of the movable object exists on the basis of an image captured by an imaging unit.

### REFERENCE SIGNS LIST

1 information processing system
10 drone
20 information processing apparatus
11, 21 control unit

1. A movable object, comprising
a control unit that controls an action of a movable object on a basis of an estimation result of estimating whether or not an obstacle that prevents movement of the movable object exists on a basis of an image captured by an imaging unit.

2. The movable object according to claim 1, wherein
the control unit causes the movable object to decelerate or hover in a case where it is estimated that the obstacle exists.

3. The movable object according to claim 1, wherein
the control unit performs processing of examining whether or not the obstacle really exists in a case where it is estimated that the obstacle exists.

4. The movable object according to claim 3, further comprising
a detection unit that detects a distance between the obstacle and the movable object, wherein
the control unit moves the movable object to a position where the detection unit is capable of detecting the distance.

5. The movable object according to claim 3, further comprising
a detection unit that detects a distance between the obstacle and the movable object, wherein
the control unit causes the detection unit to measure the distance multiple times while moving the movable object.

6. The movable object according to claim 3, wherein
the control unit causes the movable object to land or hover or generates a movement path of the movable object to avoid the obstacle in a case where the control unit determines that the obstacle really exists.

7. The movable object according to claim 1, wherein
the control unit controls the action of the movable object on a basis of an estimation result of estimating whether or not the obstacle exists by applying the image to a learner generated by applying learning data to a machine learning algorithm.

8. The movable object according to claim 1, wherein
the movable object is an aircraft.

9. The movable object according to claim 1, wherein
the obstacle is an object having transparency or translucency.

10. An information processing system, comprising:
an information processing apparatus that estimates whether or not an obstacle that prevents movement of the movable object exists on a basis of an image captured by an imaging unit; and
the movable object that controls the action of the movable object on a basis of an estimation result.

11. The information processing system according to claim 10, wherein
the information processing apparatus estimates whether or not the obstacle exists by applying the image to a learner generated by applying learning data to a machine learning algorithm.

12. The information processing system according to claim 10, wherein
the information processing apparatus is a server.

13. An information processing method, comprising
controlling an action of a movable object on a basis of an estimation result of estimating whether or not an obstacle that prevents movement of the movable object exists on a basis of an image captured by an imaging unit.

14. A program that causes a movable object to execute
a step of controlling an action of the movable object on a basis of an estimation result of estimating whether or not an obstacle that prevents movement of the movable object exists on a basis of an image captured by an imaging unit.
